(19) United States
(12) Patent Application Publication
(10) Pub. No.: US 2007/0028505 A1
(43) Pub. Date: Feb. 8, 2007

(54) Fishing lure

(76) Inventors: Robert Allen Van Wyk, Largo, FL (US); Gary R. Heisler, Middletown, CT (US)

Correspondence Address: ROBERT A. VAN WYK, # 104-16, 10801 STARKEY RD., LARGO, FL, 33777, US

(21) Appl. No.: 11/499,314

(22) Filed: Aug. 4, 2006

Related U.S. Application Data
(60) Provisional application No. 60/706,409, filed on Aug. 8, 2005.

(51) Int. Cl. A01K 85/00

(52) U.S. Cl. 43/42.13; 43/42.14; 43/42.32

(57) ABSTRACT

The present invention provides a new fishing lure construction wherein the same can be utilized for attracting fish to a hook attached to a lure resembling a swimmer. The buoyant lure has a rotatable arm assembly having a left arm attached to a first end of an elongated rod, and a right arm attached to a second end of the elongated rod, the elongated rod being rotatably positioned in a transverse linear passage passing between the shoulders of the figure of the swimmer. The left arm is angularly offset from the right arm 180 degrees, the hands of the arms being positioned such that when the lure is drawn across the surface of a body of water by an eyelet in the region of the head portion of the figure, the arms rotate imparting a paddling motion to the figure. At least one hook is attached to the bottom portion of the lure. In a preferred embodiment the figure is prone and is affixed to the top surface of a miniature surfboard. In another embodiment the lure is formed like a mermaid, the back portion and tail being formed from an elastomeric material. Indicia are placed on the body portion of the lures.

### PRIORITY INFORMATION

This application claims the benefit of U.S. Provisional Application Ser. No. 60/706,409, filed Aug. 8, 2005, the content of which is hereby incorporated by reference herein in its entirety.

### FIELD OF THE INVENTION

The present invention relates to fishing lures and more particularly pertains to a fishing lure for attracting fish to a hook attached to a buoyant lure resembling a human figure and which mimics the paddling motion of a swimmer.

### BACKGROUND OF THE INVENTION

The use of fishing lures is well known in the prior art. More specifically fishing lures heretofore devised and utilized are known to consist basically of familiar, expected and obvious structural configurations, notwithstanding the myriad of designs encompassed by the crowded prior art which have been developed for the fulfillment of countless objectives and requirements.

Novelty fishing lures, that is, lures fashioned to resemble familiar objects, are well known in the art. Such lures have a dual purpose, that is, to attract fish to a hook, and also to attract a purchaser to a point of sale.

In these respects, the fishing lure according to the present invention substantially departs from the conventional concepts and designs of the prior art, and in so doing provides an apparatus primarily developed for the purpose of attracting fish to a hook attached to a lure resembling a human swimmer. Indicia on the apparatus identify a brand or location, thereby giving the lure value as a souvenir or novelty object or for advertising.

### SUMMARY OF THE INVENTION

The present invention provides a new fishing lure construction wherein the same can be utilized for attracting fish to a hook attached to a lure resembling a swimmer. The buoyant lure has a rotatable arm assembly having a left arm attached to a first end of an elongated rod, and a right arm attached to a second end of the elongated rod, the elongated rod being rotatably positioned in a transverse linear passage passing between the shoulders of the figure of the swimmer. The left arm is angularly offset from the right arm 180 degrees, the hands of the arms being positioned such that when the lure is drawn across the surface of a body of water by an eyelet in the region of the head portion of the figure, the arms rotate imparting a paddling motion to the figure. At least one hook is attached to the bottom portion of the lure. In a preferred embodiment the human figure is prone and is affixed to the top surface of a miniature surfboard. Indicia are placed on the back of the swimmer. The paddling motion causes the lure to oscillate in the water approximately in the plane of the surface of the water, and in a plane normal to the longitudinal axis of the lure. The legs of the figure may be integral with the trunk of the figure, or may pivot in the plane of the upper surface of the surfboard, or may be made from an elastomeric material, the action of the pivoting and elastomeric legs making the lure more attractive to fish.

Modifications may be made to the rotating arms assembly for more efficient paddling action. For instance, in another preferred embodiment the left arm and right arm are each formed to have a first arm portion and a second arm portion, the arm portions being joined at the shoulder portion, the first arm portion and the second arm portion being displaced 180 degrees from each other in a plane normal to the rod. The right arms and left arms are rotated from each other 90 degrees such that when the lure is drawn through the water at least one arm portion is always substantially submerged in the water.

In another preferred embodiment the figure of the swimmer is formed like that of a mermaid, the body portion having a rigid portion and an elastomeric portion forming a tail.

Other embodiments are anticipated including human swimmers without surfboards. In some embodiments the figures are supine such that the paddling motion of the arms causes the lure to mimic the motions of a swimmer doing a back-stroke.

The lure body portions may be formed of buoyant materials including wood or polymeric foam, or may be polymeric assemblies having voids in predetermined locations to achieve required buoyancy.

The general purpose of the present invention, which will be described subsequently in greater detail, is to provide a new fishing lure apparatus and method which has many novel features that result in a new fishing lure which is not anticipated, rendered obvious, suggested, or even implied by any of the prior art fishing lures, either alone or in any combination thereof.

There have thus been outlined, rather broadly, the more important features of the invention in order that the detailed description thereof that follows may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is a plan view of a novelty fishing lure constructed in accordance with the principles of this invention.

FIG. 2 is a side elevational view of the objects of FIG. 1.

FIG. 3 is a plan view of an alternate embodiment

FIG. 4 is a side elevational view of the objects of FIG. 3.

### DETAILED DESCRIPTION OF THE PREFERRED EMBODIMENTS

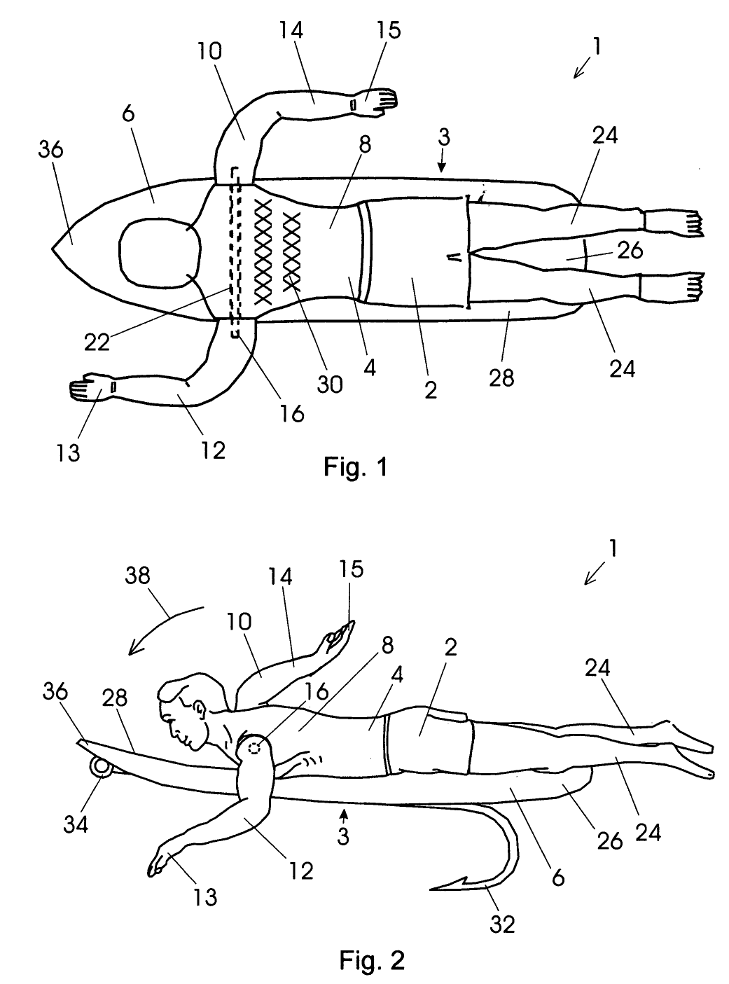

Referring to FIGS. 1 and 2 showing a preferred embodiment of the invention herein disclosed, fishing lure 1 formed from a buoyant material, has a body 3 formed by an upper portion 2 forming a prone human body, and a lower portion 6 forming a miniature surfboard. Upper portion 2 is an assembly having a fixed portion 8 forming the head and trunk of the body, and a movable assembly 10 formed by left arm 12 with hand 13, right arm 14 with hand 15, and axle 16 which joins arms 12 and 14. Arms 12 and 14 are angularly offset 180 degrees about the axis of rod 16. Left hand 13 and right hand 15 are “cupped” in the manner of a swimmer's hands. Rod 16 is pivotally positioned in transverse cylindrical passage 22 in fixed portion 8 of upper portion 2. Legs 24 protrude beyond back end 26 of lower portion 6. In a preferred embodiment legs 24 are integral with fixed portion 8. In other embodiments legs 24 are formed from an elastomeric material. In still other embodiments legs 24 are formed from a rigid material and are pivotably mounted to fixed portion 8 and lower portion 6 such that legs 24 pivot in a plane approximately parallel to upper surface 28 of lower portion 6. Indicia 30 are printed on or formed into fixed portion 8 of upper portion 2, or on or into lower portion 6. Lower portion 6 has molded into or affixed to it fishhook 32, and eyelet 34 hear front end 36.

In use, a fishing line is attached to eyelet 34, and lure 1 is drawn over the surface of a body of water. Left hand 13 penetrates the surface of the water. A force caused by the water acting on left hand 13 and left arm 12 causes rotatable assembly 10 to rotate about the axis of axle 16 in direction 38 when viewed as in FIG. 2. This motion continues as left hand 13 and arm 12 reach the surface of the water and emerge, and right hand 15 penetrates the surface of the water. The motion of rotatable assembly 10 continues as long as lure 1 is drawn across the surface of the water so as to cause lure 1 to mimic the appearance of a surfboard paddled by a prone rider. The paddling motion of rotating assembly 10 causes the lure to oscillate approximately in the plane of the water's surface, the frequency of the oscillation matching that of the rate of rotation of assembly 10. Embodiments having legs 24 made from a resilient polymeric material, or legs 24 which are pivotally mounted, trail behind the main portion of the lure so as to mimic the motion of the legs of a prone surfer paddling a surfboard.

In other embodiments hands 13 and 15 are pivotally attached to arms 12 and 14, the axis of the attachments being approximately parallel to the axis of axle 16. The angular motion of hands 13 and 15 are limited relative to arms 12 and 14 such that the hands penetrate the water more effectively during rotation.

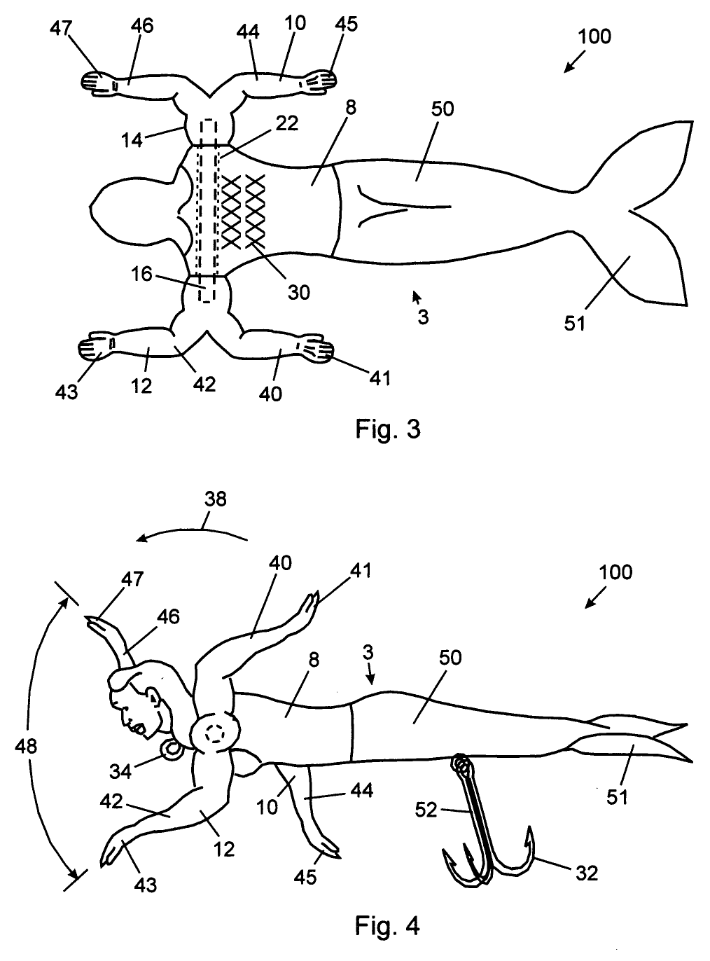

Referring now to FIGS. 3 and 4 showing an alternate embodiment designed for increased rotation of rotatable assembly 10, lure 100, formed in the shape of a mermaid, is an assembly having a fixed, rigid portion 8 forming the head and trunk of the body, an elastomeric portion, and a rotatable assembly 10 formed by left arm portion 12 with hands 13, right arm portion 14 with hands 15, and rod 16 which joins arm portions 12 and 14. Left arm portion 12 has a first portion 40 having a first hand portion 41 and a second portion 42 having a second hand portion 43, portion 42 being identical in form to portion 40, but angularly displaced therefrom 180 degrees about the axis of rod 16 to which left arm portion 12 is attached. Similarly, right arm portion 14 has a first portion 44 having a first hand portion 45, and a second portion 46 having a second hand portion 47, portion 46 being identical to portion 44, but angularly displaced therefrom 180 degrees about the axis of rod 16 to which right arm portion 14 is attached. Left arm portion 12 is displaced from right arm portion 14 by angle 48 equal to approximately 90 degrees. Hand portions 41, 43, 45 and 47 are “cupped” in the manner of a swimmer's hands. Rod 16 is rotatably positioned in transverse cylindrical passage 22 in fixed portion 8 of lure 100. Elastomeric portion 50 of lure 100, mounted by a means to rigid portion 8, is formed from a suitable polymeric material, such as, for instance, silicone. Portion 50 has a tail 51 formed on its distal end and an eyelet 52 in its lower surface, eyelet 52 being mechanically linked to eyelet 34 by a means internal to lure 100. Treble hook 32 is attached to eyelet 52. Indicia 30 are printed on or formed into portion 8.

In use, a fishing line is attached to eyelet 34, and lure 100 is drawn over the surface of a body of water. The force of water acting upon the hand portions and arm portions of assembly 10 causes assembly 10 to rotate in direction 38 (FIG. 2). Left hand 43 penetrates the surface of the water causing movable assembly 10 to rotate about the axis of rod 16 in direction 38. When movable assembly 10 has rotated approximately 90 degrees beyond the point of entry into the water of left hand 43, hand 47 of right arm portion 46 penetrates the surface of the water. Rotation continues as successively hand portion 41 and arm portion 40, and hand portion 45 and arm portion 44 penetrate the surface of the water. The rotation continues as long as lure 100 is drawn over the surface of the water.

Rigid body portions of lures 1 and 100, and of other embodiments formed in accordance with the principles of this invention, may be formed from one or more buoyant materials such as, for instance, wood or polymeric foam, or may be formed as an assembly of injection molded polymeric components, or may be formed from a combination of buoyant materials and molded polymeric components. Body portions may contain voids in predetermined locations in order to achieve required buoyancy. These voids in the body portions may be distributed so as to achieve a distribution of buoyancy in the lure in order to achieve a desired action when the lure is drawn across the surface of a body of water. For instance, lure 1 may have voids in the forward portions of lower portion 6 and of upper portion 4 so as to cause the front portion of the lure to be slightly above the surface of the water when the lure is drawn across the surface. Also, in some embodiments it may be necessary to add ballast to the rearward portion of the lure so as to achieve a desired action when the lure is drawn across the surface of a body of water.

What is claimed is:

1. A buoyant fishing lure comprising:
a body portion;
a means for attaching the body portion to the end of a fishing line;
at least one hook attached to the body portion; and,
a rotatable portion, the axis of the rotatable portion being transverse to the axis of the body portion;
such that when said lure is drawn across the surface of a body of water, portions of the rotatable portion penetrate the surface of the water thereby causing the rotatable portion to rotate.

2. The lure of claim 1 wherein the elongated body portion has the form of a human body and the rotatable portion forms the arms of the body such that when said lure is drawn across the surface of a body of water, the arms of the rotatable portion produce a paddling motion like that of a swimmer, said rotatable portion comprising an elongated rod, a left arm portion assembled to the first end of the elongated rod, and a right arm portion assembled to the second end of the elongated rod.

3. The lure of claim 2 wherein the elongated body portion further comprises a miniature surfboard positioned and scaled so that the human body is prone on the surfboard.

4. The lure of claim 2 wherein the elongated body portion comprises a rigid portion and an elastomeric portion

5. The lure of claim 4 wherein said elastomeric portion forms the legs of the human body.

6. The lure of claim 2 further comprising a pivotally mounted portion comprising the legs of the human body.

7. The lure of claim 2 wherein the left arm portion comprises two arm portions angularly displaced 180 degrees from each other about the axis of said rod, the right arm portion comprises two arm portions angularly displaced 180 degrees from each other about the axis of the rod, and the right arm portions and left arm portions are angularly displaced from each other 90 degrees about the axis of said rod.

8. The lure of claim 1 where said body comprises a buoyant material.

9. The lure of claim 1 wherein said lure comprises molded polymeric components.

10. The lure of claim 1 further comprising voids at predetermined locations within said body.

11. The lure of claim 1 further comprising ballast at predetermined locations in said body.

12. The lure of claim 1 wherein the elongated body portion has the form of a mermaid and the rotatable portion forms arms which produce a motion like that of a swimmer when said lure is drawn across the surface of a body of water.

13. The lure of claim 12 wherein the elongated body portion has a rigid portion forming the upper trunk of the body, and an elastomeric portion forming the lower trunk and tail of the mermaid.
